(19) United States
(12) Patent Application Publication
(10) Pub. No.: US 2024/0191411 A1
(43) Pub. Date: Jun. 13, 2024

(54) POLYPROPYLENE FABRIC STRUCTURE, MANUFACTURING METHOD THEREOF, AND PROTECTIVE CLOTHING

(71) Applicant: FORMOSA PLASTICS CORPORATION, Kaohsiung City (TW)

(72) Inventors: Kwang-Ming CHEN, Kaohsiung City (TW); Jung-Hung KAO, Kaohsiung City (TW); Kun-Pei HSIEH, Kaohsiung City (TW); Han-Chung LIAO, Kaohsiung City (TW); Chun-Tsung CHEN, Kaohsiung City (TW); Chao-Shun CHANG, Kaohsiung City (TW); Yao-Tsung HSIEH, Kaohsiung City (TW); Chia-Yi WEI, Kaohsiung City (TW)

(21) Appl. No.: 18/181,305

(22) Filed: Mar. 9, 2023

(30) Foreign Application Priority Data
Dec. 13, 2022 (TW) 111147875

(51) Int. Cl. D04H 3/16; D04H 3/007

(52) U.S. Cl. CPC D04H 3/16; D04H 3/007; D10B 2321/022; D10B 2401/063; D10B 2501/04

(57) ABSTRACT

A polypropylene fabric structure, a manufacturing method thereof, and a protective clothing including the polypropylene fabric structure are provided. The polypropylene fabric structure includes a polypropylene spunbond nonwoven fabric and a polypropylene meltblown nonwoven fabric. The polypropylene meltblown nonwoven fabric is directly bonded to the polypropylene spunbond nonwoven fabric. The polypropylene meltblown nonwoven fabric is made of a material including polypropylene having a melt flow index between 1700 g/10 min and 2000 g/10 min and a melting point between 155° C. and 165° C.

### CROSS-REFERENCE TO RELATED APPLICATION

This application claims priority to Taiwan Application Serial Number 111147875, filed Dec. 13, 2022, which is herein incorporated by reference.

### BACKGROUND

### Field of Invention

The present disclosure relates to a polypropylene fabric structure, a manufacturing method thereof, and protective clothing.

### Description of Related Art

There are many kinds of protective clothing on the market to allow users to protect themselves in various workplaces. Medical protective clothing in medical institutions can prevent the source of biological infection or patient body fluids from contacting medical personnel and causing disease transmission. In an operating room, intensive care unit, and emergency room, germs spread quite easily, so medical protective clothing is the basic equipment in these places. In addition, to avoid transmitting germs to patients when the general public enters the intensive care unit to visit the patients, the medical institutions will also require the public to wear protective clothing to reduce the risk of infection.

Medical protective clothing can reduce the number of germs on the protective clothing by washing it after use, but the protective clothing may still be contaminated during the washing process, so disposable medical protective clothing is widely used. To improve the protective effect, general disposable medical protective clothing usually includes a variety of fabrics and/or coatings of different materials. However, this causes the problem that the protective clothing is not easy to be recycled.

### SUMMARY

The present disclosure provides a polypropylene (PP) fabric structure that includes a polypropylene spunbond nonwoven fabric and a polypropylene meltblown nonwoven fabric. The polypropylene meltblown nonwoven fabric is directly bonded to the polypropylene spunbond nonwoven fabric. The polypropylene meltblown nonwoven fabric is made of a material including polypropylene having a melt flow index (MI) between 1700 g/10 min and 2000 g/10 min and a melting point between 155° ° C. and 165° C.

In some embodiments, the material further includes low melting point polypropylene, and the low melting point polypropylene has a melting point between 129° C. and 135° C.

In some embodiments, a total weight of the material is 100 wt %, and the low melting point polypropylene is from 1 wt % to 10 wt %.

In some embodiments, the polypropylene spunbond nonwoven fabric has a basis weight of 30 gsm to 60 gsm, and the polypropylene meltblown nonwoven fabric has a basis weight of 30 gsm to 60 gsm.

The present disclosure provides protective clothing including the polypropylene fabric structure of any one of aforementioned embodiments.

The present disclosure provides a method of manufacturing a polypropylene fabric structure, and the method includes thermally pressing a polypropylene spunbond nonwoven fabric and a polypropylene meltblown nonwoven fabric, in which a thermal pressing temperature is greater than 70° C. The polypropylene meltblown nonwoven fabric is made of a material including polypropylene having a melt flow index between 1700 g/10 min and 2000 g/10 min and a melting point between 155° C. and 165° C.

In some embodiments, thermally pressing the polypropylene spunbond nonwoven fabric and the polypropylene meltblown nonwoven fabric includes the following operation: making the polypropylene spunbond nonwoven fabric and the polypropylene meltblown nonwoven fabric pass between an upper roller and a lower roller, in which the polypropylene spunbond nonwoven fabric and the polypropylene meltblown nonwoven fabric are stacked, and the upper roller and the lower roller apply a linear pressure of 25 kg/cm to 120 kg/cm.

In some embodiments, roller temperatures of the upper roller and the lower roller are respectively from 70° C. to 130° C.

In some embodiments, a roller gap between the upper roller and the lower roller is from 0.04 mm to 0.5 mm.

In some embodiments, the material further includes low melting point polypropylene, and the low melting point polypropylene has a melting point between 129° C. and 135° C.

It is to be understood that the foregoing general description and the following detailed description are merely exemplary and explanatory, and are intended to provide further illustration of the present disclosure.

### BRIEF DESCRIPTION OF THE DRAWINGS

The disclosure can be more fully understood by reading the following detailed description of the embodiments, with reference made to the accompanying drawings as follows:

FIG. 1 is a cross-section view of a polypropylene fabric structure in accordance with various embodiments of the present disclosure.

FIG. 2 is a cross-section view of an intermediate stage of manufacturing a polypropylene fabric structure in accordance with various embodiments of the present disclosure.

### DETAILED DESCRIPTION

Reference will now be made in detail to the embodiments of the present disclosure, examples of which are illustrated in the accompanying drawings. Wherever possible, the same reference numbers are used in the drawings and the description to refer to the same or like parts.

The following embodiments are disclosed with accompanying diagrams for detailed description. For illustration clarity, many details of practice are explained in the following descriptions. However, it should be understood that these details of practice do not intend to limit the present disclosure. That is, these details of practice are not necessary in parts of embodiments of the present disclosure. Furthermore, for simplifying the drawings, some of the conventional structures and elements are shown with schematic illustrations.

Generally, protective clothing may include a variety of fabrics and/or coatings of different materials to enhance the protective effect, thereby meeting the specification standard for protective clothing. For example, disposable medical protective clothing may include both a polypropylene (PP) layer and a polyethylene (PE) layer, and the combination of the two materials can make the protective clothing meet the requirements of medical protective clothing. However, this medical protective clothing is not easy to be recycled due to the dissimilar materials. The present disclosure provides a polypropylene fabric structure that is a composite fabric including a polypropylene spunbond nonwoven fabric and a polypropylene meltblown nonwoven fabric. In the case that the polypropylene fabric structure does not include a polyethylene fabric and/or a polyethylene coating, the polypropylene fabric structure can have the physical properties that meet the specification standard for protective clothing at a level of P1 to P3 and the fabric strength suitable for protective clothing. Moreover, since the polypropylene fabric structure of the present disclosure may not include polyethylene material, the protective clothing made of the polypropylene fabric structure is easy to be recycled and has the advantage of being environmentally friendly.

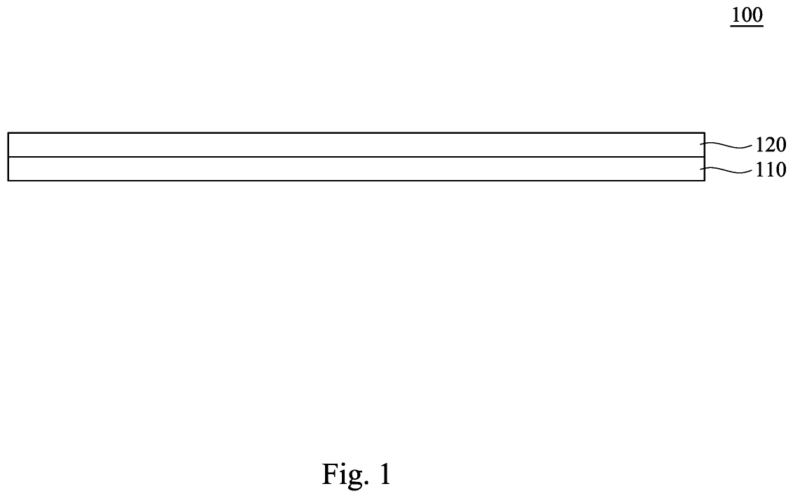

Referring to FIG. 1, it is a cross-section view of a polypropylene fabric structure 100 in accordance with various embodiments of the present disclosure. The polypropylene fabric structure 100 includes a polypropylene spunbond nonwoven fabric 110 and a polypropylene meltblown nonwoven fabric 120. The polypropylene meltblown nonwoven fabric 120 is directly bonded to the polypropylene spunbond nonwoven fabric 110. The polypropylene meltblown nonwoven fabric 120 is made of a material including polypropylene having a melt flow index (MI) between 1700 g/10 min and 2000 g/10 min and a melting point between 155° C. and 165° C. In some embodiments, the melt flow index of the polypropylene is 1700, 1750, 1800, 1850, 1900, 1950, or 2000 g/10 min. In some embodiments, the melting point of the polypropylene is 155, 157, 159, 161, 163, or 165° C.

The method for measuring the melt flow index of polypropylene includes heating the polypropylene at 230° ° C. for 240 seconds and measuring the weight of the polypropylene passing through a hole of a mold every 10 minutes under a load of 2.16 kg. The diameter of the mold is 9.5504±0.0076 mm, the height of the mold is 8.000±0.025 mm, and the hole is 2.095±0.005 mm.

General polypropylene has a melt flow index of less than 1000 g/10 min. However, the polypropylene used for manufacturing the polypropylene meltblown nonwoven fabric 120 of the present disclosure has a higher melt flow index and therefore has better flowability. Therefore, the polypropylene can be made into polypropylene fibers with smaller diameter by a melt blowing process, and then the polypropylene fibers are made into the polypropylene meltblown nonwoven fabric 120. Since the polypropylene meltblown nonwoven fabric 120 of the present disclosure includes polypropylene fibers with small diameter, it can have good sub-micron particulate filtration efficiency. In some embodiments, the polypropylene meltblown nonwoven fabric 120 includes polypropylene fibers having a diameter of less than 4 μm. The polypropylene fibers are made of polypropylene having a melt flow index between 1700 g/10 min and 2000 g/10 min and a melting point between 155° C. and 165° C. In some embodiments, the polypropylene fibers have a diameter of 1.5 μm to 4 μm, such as 1.5, 2, 2.5, 3, 3.5, or 4 μm. In some embodiments, the polypropylene meltblown nonwoven fabric 120 consists of the polypropylene fibers described above.

Please continue to refer to FIG. 1. In some embodiments, the polypropylene spunbond nonwoven fabric 110 is in direct contact with the polypropylene meltblown nonwoven fabric 120, and no polyethylene layer is interposed between them. In some embodiments, the polypropylene fabric structure 100 does not include polyethylene material. In some embodiments, the upper surface of the polypropylene meltblown nonwoven fabric 120 is not in contact with polyethylene. In some embodiments, the lower surface of the polypropylene spunbond nonwoven fabric 110 is not in contact with polyethylene. The polypropylene fabric structure 100 of the present disclosure can have excellent sub-micron particulate filtration efficiency and water pressure resistance without being used in conjunction with a polyethylene fabric and/or polyethylene coating, and has properties suitable for manufacturing a protective clothing.

In some embodiments, the polypropylene used to manufacture the polypropylene meltblown nonwoven fabric 120 is polymerized from propylene monomers, and monomers for copolymerization may be optionally added during the polymerization process. In other words, the polypropylene can be polymerized from the propylene monomers alone or polymerized from the propylene monomers and other monomers for copolymerization. This will be further illustrated below with different embodiments. In some embodiments, no other monomer for copolymerization is added to copolymerize with the propylene monomers during the polymerization process of forming the polypropylene. In some embodiments, the polypropylene used to manufacture the polypropylene meltblown nonwoven fabric 120 is polymerized from the propylene monomers only. In other embodiments, the polypropylene used to manufacture the polypropylene meltblown nonwoven fabric 120 is polymerized from the propylene monomers and the monomers for copolymerization. The monomer for copolymerization is an α-alkene compound other than propylene, such as an α-alkene compound having a carbon number of 2 to 8, preferably, for example, an α-alkene compound having a carbon number of 2 or 4, and more preferably, an α-alkene compound having a carbon number of 2. For example, the carbon number is 2, 3, 4, 5, 6, 7, or 8. In some embodiments, when the propylene monomers are 100 parts by weight, the monomers for copolymerization are less than or equal to 5 parts by weight, such as 2, 3, 4, or 5 parts by weight. The monomers for copolymerization can reduce the crystallinity of the polypropylene, which gives it a more flexible mechanical property.

In some embodiments, the polypropylene can be prepared by a Ziegler-Natta catalyst or by a metallocene catalyst. In some embodiments, the polypropylene prepared by the Ziegler-Natta catalyst has a wider molecular weight distribution, e.g., between 4 and 5. In some embodiments, the polypropylene prepared by the metallocene catalyst has a narrower molecular weight distribution, e.g., between 3 and 4. In some embodiments, the manufacturing method of the polypropylene includes mixing the propylene monomers, the Ziegler-Natta catalyst, organic aluminum compounds, and electron donors to perform polymerization to obtain the polypropylene. During the polymerization process of forming the polypropylene, monomers for copolymerization may be optionally added into the reacting system. In some embodiments, the Ziegler-Natta catalyst is produced by reacting a titanium compound attached on magnesium chloride with a phthalate compound, a diol ester compound, a diether compound, and/or a succinate compound. For example, the phthalate compound may include, but is not limited to, diisobutyl phthalate, di-n-butyl phthalate, di-n-propyl phthalate, diisooctyl phthalate, other suitable phthalate compound, or any combination of the above. The preparation methods and processes of the Ziegler-Natta catalyst are well known to a person having ordinary skill in the art, and therefore will not be described. In some embodiments, the electron donor includes an aminosilane compound, such as dicyclopentyl bis(ethylamino)silane, diisopropyl dimethoxy silane, cyclohexyl methyl dimethoxy silane, isobutyl isopropyl dimethoxy silane, or dicyclopentyl dimethoxy silane.

In some embodiments, the molecular weight distribution of the polypropylene of the present disclosure is greater than 2.5, so the polypropylene has a wider processing window, thus has good applicability, and can enhance the mechanical strength of the polypropylene meltblown nonwoven fabric 120. In some embodiments, the molecular weight distribution of the polypropylene is greater than or equal to 2.5 and less than or equal to 5.5.

In some embodiments, the polypropylene spunbond nonwoven fabric 110 has a basis weight of 30 gsm to 60 gsm, such as 30, 35, 40, 45, 50, 55, or 60 gsm, and the polypropylene meltblown nonwoven fabric 120 has a basis weight of 30 gsm to 60 gsm, such as 30, 35, 40, 45, 50, 55, or 60 gsm. A nonwoven fabric with smaller basis weight includes fibers with smaller diameter, and therefore can more favorably enhance the water pressure resistance of the polypropylene fabric structure 100.

In some embodiments, the material further includes low melting point polypropylene, and the low melting point polypropylene has a melting point between 129° C. and 135° C. In some embodiments, a total weight of the material is 100 wt %, and the low melting point polypropylene is from 1 wt % to 10 wt %, such as 1, 2, 3, 4, 5, 6, 7, 8, 9, or 10 wt %. The low melting point polypropylene is beneficial to improve the micron particulate filtration efficiency of the polypropylene fabric structure 100, and can greatly improve the water pressure resistance of the polypropylene fabric structure 100.

The physical properties of the polypropylene fabric structure 100 are measured according to the disposable medical protective clothing standard CNS147982. In some embodiments, the polypropylene fabric structure 100 has a sub-micron particulate filtration efficiency of 45% to 98%, such as 45, 50, 60, 70, 80, 90, 91, 92, 93, 94, 95, 96, 97, or 98%. In some embodiments, the polypropylene fabric structure 100 has a hydrostatic pressure of 460 mm-Aq to 1700 mm-Aq, such as 460, 500, 600, 700, 800, 900, 1000, 1100, 1200, 1300, 1400, 1500, 1600, or 1700 mm-Aq. In some embodiments, the polypropylene fabric structure 100 has a tensile strength (MD) of 90 N to 200 N, such as 90, 100, 120, 140, 160, 180, or 200 N. In some embodiments, the polypropylene fabric structure 100 has a tensile strength (CD) of 100 N to 180 N, such as 100, 120, 140, 160, or 180 N. MD means that the measurement is performed along the longitudinal direction of the sample, and CD means that the measurement is performed along the transverse direction of the sample. In some embodiments, the polypropylene fabric structure 100 has a bursting strength of 200 kPa to 1000 kPa, such as 200, 300, 400, 500, 600, 700, 800, 900, or 1000 kPa. In some embodiments, the polypropylene fabric structure 100 has a tearing strength (MD) of 15 N to 75 N, such as 15, 20, 30, 40, 50, 60, 70, or 75 N. In some embodiments, the polypropylene fabric structure 100 has a moisture permeability of 2500 g/m²/24 hr to 12000 g/m²/24 hr, such as 2500, 5000, 7500, 10000, 11000, or 12000 g/m²/24 hr. In some embodiments, the polypropylene fabric structure 100 has a suture strength of 50 N to 100 N, such as 50, 60, 70, 80, 90, or 100 N. In some embodiments, the polypropylene fabric structure 100 has impact penetration data of 0.09 g to 1.2 g, such as 0.09, 0.1, 0.5, 1, 1.1, or 1.2 g.

The present disclosure provides a protective clothing including the polypropylene fabric structure of any one of aforementioned embodiments. For example, the protective clothing is disposable medical protective clothing or reusable medical protective clothing. The medical protective clothing includes a surgical gown, a shoe cover, a sleeve, or a patient gown.

The present disclosure provides a method of manufacturing a polypropylene fabric structure, and the method includes thermally pressing a polypropylene spunbond nonwoven fabric and a polypropylene meltblown nonwoven fabric, in which a thermal pressing temperature is greater than 70° C. The polypropylene meltblown nonwoven fabric is made of a material including polypropylene having a melt flow index between 1700 g/10 min and 2000 g/10 min and a melting point between 155° C. and 165° C. In some embodiments, the thermal pressing temperature is between 70° C. and 130° C., for example, 70, 80, 90, 100, 110, 120, or 130° C. In some embodiments, the material further includes low melting point polypropylene, and the low melting point polypropylene has a melting point between 129° C. and 135° C. The method of manufacturing the polypropylene fabric structure of the present disclosure has a simple process and is beneficial for the mass production of protective clothing.

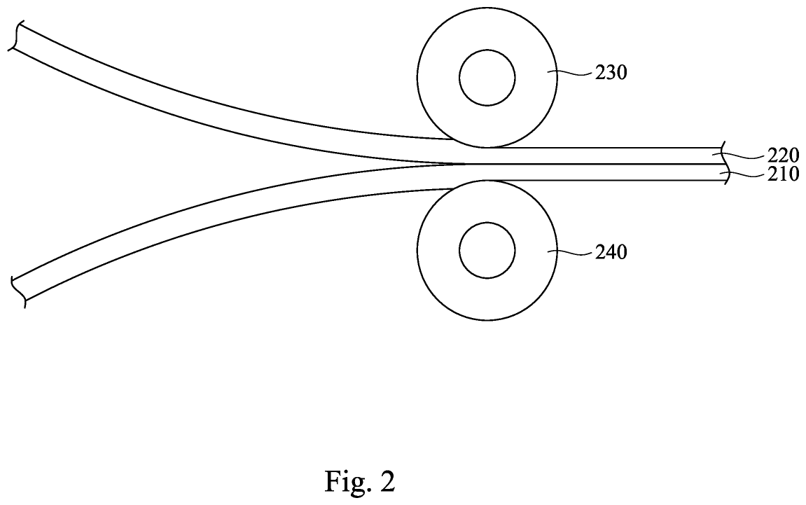

In some embodiments, thermally pressing the polypropylene spunbond nonwoven fabric and the polypropylene meltblown nonwoven fabric is performed by thermally pressing them with two hot-pressing roller to bond them to each other. The two are in direct contact during the hot-pressing process. Please refer to FIG. 2. FIG. 2 is a cross-section view of an intermediate stage of manufacturing a polypropylene fabric structure in accordance with various embodiments of the present disclosure. The polypropylene spunbond nonwoven fabric 210 and the polypropylene meltblown nonwoven fabric 220 are passed between an upper roller 230 and a lower roller 240, in which the polypropylene spunbond nonwoven fabric 210 and the polypropylene meltblown nonwoven fabric 220 are stacked, and the upper roller 230 and the lower roller 240 apply a linear pressure of 25 kg/cm to 120 kg/cm. In some embodiments, the linear pressure is 25, 30, 40, 50, 60, 70, 80, 90, 100, 110, or 120 kg/cm.

In some embodiments, the roller temperatures of the upper roller 230 and the lower roller 240 are respectively from 70° C. to 130° C. In some embodiments, the upper roller 230 and the lower roller 240 have different roller temperatures. The upper roller 230 has the roller temperature of, for example, 70, 80, 90, 100, 110, 120, or 130° C. The lower roller 240 has the roller temperature of, for example, 70, 80, 90, 100, 110, 120, or 130° C. The higher the roller temperature, the tighter the polypropylene spunbond nonwoven fabric 210 and the polypropylene meltblown nonwoven fabric 220 can be pressed during the hot pressing, thereby increasing the density and the micron particulate filtration efficiency of the polypropylene fabric structure.

In some embodiments, a roller gap between the upper roller 230 and the lower roller 240 is from 0.04 mm to 0.5 mm. The roller gap is, for example, 0.04, 0.05, 0.06, 0.07, 0.08, 0.09, 0.1, 0.2, 0.3, 0.4, or 0.5 mm. The smaller the roller gap, the tighter the polypropylene spunbond nonwoven fabric 210 and the polypropylene meltblown nonwoven fabric 220 can be pressed, thereby increasing the density and the micron particulate filtration efficiency of the polypropylene fabric structure.

The following describes the features of the present disclosure more specifically with reference to the experiments of the manufacturing and the property test of the polypropylene fabric structure. Although the following examples are described, the materials used, their amounts and ratios, processing details, and processing procedures may be changed as appropriate without going beyond the scope of the present disclosure. Accordingly, this disclosure should not be interpreted restrictively by the examples described below.

In the experiment, the polypropylene fabric structures of Comparative Examples 1 to 2, Examples 1-A to 1-C, Examples 2-A to 2-C, and Examples 3-A to 3-E were made by thermally pressing a polypropylene (PP) spunbond nonwoven fabric and a polypropylene (PP) meltblown nonwoven fabric that are in contact with each other between an upper roller and a lower roller. The polypropylene fabric structures were then tested respectively for the properties. The material and basis weight of the fabrics used to form the fabric structures are shown in Table 1 below, in which the fabrics MB1 to MB3 all include PP with a melt flow index (MI) of about 1700 to 1900 g/10 min. The PP can be formed by polymerizing propylene monomers, or copolymerizing propylene monomers with monomers for copolymerization that are optionally added during the polymerization process. The monomer for copolymerization is an α-alkene compound having a carbon number of 2 to 8 other than propylene. The fabrics MB2 and MB3 further include low melting point PP with a melting point between 129° C. and 135° C. Please refer to Table 2 for the thermal pressing conditions used for manufacturing the fabric structures.

TABLE 1

| | | Base | |
|---|---|---|---|
| | | weight | |
| Fabric | Type | (gsm) | Material |
| SB | PP spunbond | 40 | PP |
| | nonwoven | | |
| | fabric | | |
| MB | PP meltblown | 40 | PP purchased from LyondellBasell |
| | nonwoven | | Industries, product model: MF650Y |
| | fabric | | |
| MB1 | PP meltblown | 40 | PP (MI: 1700-1900 g/10 min) |
| | nonwoven | | without being added with low |
| | fabric | | melting point PP |
| MB2 | PP meltblown | 40 | PP (MI: 1700-1900 g/10 min) + |
| | nonwoven | | low melting point PP (5wt %) |
| | fabric | | |
| MB3 | PP meltblown | 50 | PP (MI: 1700-1900 g/10 min) + |
| | nonwoven | | low melting point PP (5 wt %) |
| | fabric | | |

TABLE 2

| | Upper roller | Lower roller | Roller | Linear |
|---|---|---|---|---|
| | temperature | temperature | gap | pressure |
| | (° C.) | (° C.) | (mm) | (kg/cm) |
| Thermal pressing | 80 | 80 | 0.3 | 50 |
| condition A | | | | |
| Thermal pressing | 100 | 80 | 0.2 | 100 |
| condition B | | | | |
| Thermal pressing | 110 | 80 | 0.1 | 100 |
| condition C | | | | |
| Thermal pressing | 110 | 110 | 0.1 | 100 |
| condition D | | | | |
| Thermal pressing | 110 | 110 | 0.05 | 100 |
| condition E | | | | |

The tested properties of the polypropylene fabric structures of Comparative Examples 1 to 2 and Examples 1-A to 1-C are shown in Table 3 below. The tested properties of the polypropylene fabric structures of Examples 2-A to 2-C are shown in Table 4 below. The tested properties of the polypropylene fabric structures of Examples 3-A to 3-E are shown in Table 5 below, in which MD means that the measurement is performed along the longitudinal direction of the sample, and CD means that the measurement is performed along the transverse direction of the sample. In addition, since the disposable medical protective clothing standard CNS14798 classifies the protective clothing levels into three levels P1, P2, and P3, the test items and specifications of P1, P2, and P3 are listed in Tables 3, 4, and 5 below for comparison with the physical properties of the polypropylene fabric structures of the present disclosure.

TABLE 3

| | | Comparative | Comparative | Example | Example | Example | | | |
|---|---|---|---|---|---|---|---|---|---|
| | | Example 1 | Example 2 | 1-A | 1-B | 1-C | | | |
| | | (SB + MB) | (SB + MB) | (SB + MB1) | (SB + MB1) | (SB + MB1) | | | |
| | | Thermal pressing condition | | | | | | | |
| | | No thermal | | | | | | | |
| | | pressing | A | A | B | C | P1 | P2 | P3 |
| Hydrostatic | | 150 | 245 | 486 | 490 | 570 | ≥200 | ≥500 | ≥1400 |
| pressure | | | | | | | | | |
| (mm-Aq) | | | | | | | | | |
| Sub-micron | | | | 48.6 | 50.8 | 59.2 | N/A | ≥70 | N/A |
| particulate | | | | | | | | | |
| filtration | | | | | | | | | |
| efficiency (%) | | | | | | | | | |
| Tensile | MD | | 158.1 | 110.7 | 169.8 | 183.2 | N/A | ≥50 | ≥50 |
| strength | CD | | 113.9 | 144 | 150.4 | 169.6 | N/A | ≥40 | ≥40 |
| (N) | | | | | | | | | |
| Bursting | | | 303.4 | 331 | 975 | 876 | N/A | ≥200 | ≥200 |
| strength (kPa) | | | | | | | | | |
| Tearing | MD | | 46.9 | 52 | 17.6 | 20.7 | N/A | ≥20 | ≥20 |
| strength | CD | | 64.7 | 34 | 17 | 24.8 | N/A | ≥20 | ≥20 |
| (N) | | | | | | | | | |

| | | | | | | | |
|---|---|---|---|---|---|---|---|
| Moisture | 12096 | 11485 | 2657 | 2543 | N/A | ≥1500 | ≥1500 |
| permeability | | | | | | | |
| (g/m²/24 hr) | | | | | | | |
| Suture | | | 92 | 78 | N/A | ≥20 | ≥20 |
| strength (N) | | | | | | | |
| Impact | 0.1 | 0.1 | 1.1 | 0.8 | ≤4.5 | ≤1.0 | ≤0.5 |
| penetration (g) | | | | | | | |
| Synthetic | | | | | N/A | N/A | No |
| blood | | | | | | | |
| penetration | | | | | | | |
| Virus | | | | | N/A | N/A | No |
| penetration | | | | | | | |

TABLE 4

| | | Example 2-A | Example 2-B | Example 2-C | | | |
|---|---|---|---|---|---|---|---|
| | | (SB + MB2) | (SB + MB2) | (SB + MB2) | | | |
| | | Thermal pressing condition | | | | | |
| | | A | B | C | P1 | P2 | P3 |
| Hydrostatic pressure | | 827 | 1050 | 1250 | ≥200 | ≥500 | ≥1400 |
| (mm-Aq) | | | | | | | |
| Sub-micron particulate | | 62.3 | 68.4 | 68.9 | N/A | ≥70 | N/A |
| filtration efficiency (%) | | | | | | | |
| Tensile | MD | 104.6 | 108.7 | 114.8 | N/A | ≥50 | ≥50 |
| strength (N) | CD | 153 | 112.4 | 120.4 | N/A | ≥40 | ≥40 |
| Bursting strength (kPa) | | 386 | 394.2 | 388.3 | N/A | ≥200 | ≥200 |
| Tearing | MD | 62.7 | 58.4 | 59.7 | N/A | ≥20 | ≥20 |
| strength (N) | CD | 38.3 | 31.7 | 32.8 | N/A | ≥20 | ≥20 |

| | | | | | | |
|---|---|---|---|---|---|---|
| Moisture permeability | 10271 | 10248 | 10048 | N/A | ≥1500 | ≥1500 |
| (g/m²/24 hr) | | | | | | |
| Suture strength (N) | | | | N/A | ≥20 | ≥20 |
| Impact penetration (g) | 0.1 | 0.1 | 0.1 | ≤4.5 | ≤1.0 | ≤0.5 |
| Synthetic blood | | | | N/A | N/A | No |
| penetration | | | | | | |
| Virus penetration | | | | N/A | N/A | No |

TABLE 5

| | | Example | Example | Example | Example | Example | | | |
|---|---|---|---|---|---|---|---|---|---|
| | | 3-A | 3-B | 3-C | 3-D | 3-E | | | |
| | | (SB + MB3) | (SB + MB3) | (SB + MB3) | (SB + MB3) | (SB + MB3) | | | |
| | | Thermal pressing condition | | | | | | | |
| | | A | B | C | D | E | P1 | P2 | P3 |
| Hydrostatic | | 881 | 1100 | 1150 | 725 | 1673 | ≥200 | ≥500 | ≥1400 |
| pressure | | | | | | | | | |
| (mm-Aq) | | | | | | | | | |
| Sub-micron | | 66.1 | 69.1 | 68.2 | 93.61 | 96.99 | N/A | ≥70 | N/A |
| particulate | | | | | | | | | |
| filtration | | | | | | | | | |
| efficiency (%) | | | | | | | | | |
| Tensile | MD | 99.4 | 98.5 | 97.3 | 117.9 | 114.6 | N/A | ≥50 | ≥50 |
| strength | CD | 138.1 | 130.1 | 132.4 | 149.4 | 143 | N/A | ≥40 | ≥40 |
| (N) | | | | | | | | | |
| Bursting | | 448.2 | 298.6 | 300.5 | 206.9 | 234.4 | N/A | ≥200 | ≥200 |
| strength (kPa) | | | | | | | | | |
| Tearing | MD | 70 | 33.6 | 48.6 | 63.8 | 51.3 | N/A | ≥20 | ≥20 |
| strength | CD | 34.8 | 23.9 | 31.7 | 37.6 | 33.4 | N/A | ≥20 | ≥20 |
| (N) | | | | | | | | | |

| | | | | | | | | |
|---|---|---|---|---|---|---|---|---|
| Moisture | 11688 | 10839 | 10131 | 11787 | 11875 | N/A | ≥1500 | ≥1500 |
| permeability | | | | | | | | |
| (g/m²/24 hr) | | | | | | | | |
| Suture | | | | 55.3 | 65.4 | N/A | ≥20 | ≥20 |
| strength (N) | | | | | | | | |
| Impact | 0.1 | 0 | 0.1 | 0 | 0 | ≤4.5 | ≤1.0 | ≤0.5 |
| penetration (g) | | | | | | | | |
| Synthetic | | | | | | N/A | N/A | No |
| blood | | | | | | | | |
| penetration | | | | | | | | |
| Virus | | | | | | N/A | N/A | No |
| penetration | | | | | | | | |

Please refer to Table 3 to Table 5. From the experimental results of Comparative Examples 1 to 2 and Example 1-A to Example 3-E, it can be seen that the thermal pressing conditions A to E used in the present disclosure can effectively enhance the densities of the polypropylene fabric structures and improve their sub-micron particulate filtration efficiencies. The polypropylene fabric structures of Example 1-A to Example 3-C can meet the requirements of protective clothing at P1 level. The polypropylene fabric structure of Example 3-D can meet the requirements of protective clothing at P2 level. The polypropylene fabric structure of Example 3-E can meet the requirements of protective clothing at P3 level.

From the experimental results of Example 1-A to Example 1-C, Example 2-A to Example 2-C, and Example 3-A to Example 3-E, it can be seen that the present disclosure can improve the sub-micron particulate filtration efficiencies of the polypropylene fabric structures by increasing the roller temperature, reducing the roller gap, and increasing the linear pressure.

The fabric MB1 of Example 1-A to Example 1-C does not include low melting point PP. The fabric MB2 of Example 2-A to Example 2-C and the fabric MB3 of Example 3-A to Example 3-E both include 5 wt % low melting point PP. From the experimental results in Tables 3 to 5, it can be seen that the addition of the low melting point PP is beneficial to enhance the micron particulate filtration efficiencies of the fabric structures and can significantly improve the water pressure resistance of the fabric structures.

In summary, the properties of the polypropylene fabric structures of the present disclosure can meet the requirements of medical protective clothing at P1 level to P3 level. Moreover, since the fabric of the entire medical protective clothing can consist of the polypropylene fabric structure of the present disclosure, it is advantageous to recycle the protective clothing after use, and the protective clothing has the advantage of being environmentally friendly. Moreover, the method of manufacturing the polypropylene fabric structure of the present disclosure has a simple process and is also advantageous for mass production of protective clothing.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A polypropylene fabric structure, comprising:
a polypropylene spunbond nonwoven fabric; and
a polypropylene meltblown nonwoven fabric directly bonded to the polypropylene spunbond nonwoven fabric, wherein the polypropylene meltblown nonwoven fabric is made of a material comprising polypropylene having a melt flow index between 1700 g/10 min and 2000 g/10 min and a melting point between 155° C. and 165° C.

2. The polypropylene fabric structure of claim 1, wherein the material further comprises low melting point polypropylene, and the low melting point polypropylene has a melting point between 129° C. and 135° C.

3. The polypropylene fabric structure of claim 2, wherein a total weight of the material is 100 wt %, and the low melting point polypropylene is from 1 wt % to 10 wt %.

4. The polypropylene fabric structure of claim 1, wherein the polypropylene spunbond nonwoven fabric has a basis weight of 30 gsm to 60 gsm, and the polypropylene meltblown nonwoven fabric has a basis weight of 30 gsm to 60 gsm.

5. Protective clothing, comprising the polypropylene fabric structure of claim 1.

6. The protective clothing of claim 5, wherein the material further comprises low melting point polypropylene, and the low melting point polypropylene has a melting point between 129° C. and 135° C.

7. The protective clothing of claim 6, wherein a total weight of the material is 100 wt %, and the low melting point polypropylene is from 1 wt % to 10 wt %.

8. The protective clothing of claim 5, wherein the polypropylene spunbond nonwoven fabric has a basis weight of 30 gsm to 60 gsm, and the polypropylene meltblown nonwoven fabric has a basis weight of 30 gsm to 60 gsm.

9. A method of manufacturing a polypropylene fabric structure, comprising:
thermally pressing a polypropylene spunbond nonwoven fabric and a polypropylene meltblown nonwoven fabric, a thermal pressing temperature being greater than 70° C., wherein the polypropylene meltblown nonwoven fabric is made of a material comprising polypropylene having a melt flow index between 1700 g/10 min and 2000 g/10 min and a melting point between 155° C. and 165° C.

10. The method of claim 9, wherein thermally pressing the polypropylene spunbond nonwoven fabric and the polypropylene meltblown nonwoven fabric comprises:
making the polypropylene spunbond nonwoven fabric and the polypropylene meltblown nonwoven fabric pass between an upper roller and a lower roller, wherein the polypropylene spunbond nonwoven fabric and the polypropylene meltblown nonwoven fabric are stacked, and the upper roller and the lower roller apply a linear pressure of 25 kg/cm to 120 kg/cm.

11. The method of claim 10, wherein roller temperatures of the upper roller and the lower roller are respectively from 70° C. to 130° C.

12. The method of claim 10, wherein a roller gap between the upper roller and the lower roller is from 0.04 mm to 0.5 mm.

13. The method of claim 9, wherein the material further comprises low melting point polypropylene, and the low melting point polypropylene has a melting point between 129° C. and 135° C.

14. The method of claim 10, wherein the material further comprises low melting point polypropylene, and the low melting point polypropylene has a melting point between 129° C. and 135° C.

15. The method of claim 11, wherein the material further comprises low melting point polypropylene, and the low melting point polypropylene has a melting point between 129° C. and 135° C.

16. The method of claim 12, wherein the material further comprises low melting point polypropylene, and the low melting point polypropylene has a melting point between 129° C. and 135° C.
